(19) United States
(12) Patent Application Publication
(10) Pub. No.: US 2026/0077409 A1
(43) Pub. Date: Mar. 19, 2026

(54) CONTROLLER FOR A LASER POWDER BED FUSION PRINTER

(71) Applicant: Queen's University at Kingston, Kingston (CA)

(72) Inventors: Vahid Fallah, Kingston (CA); Arash Nikniazi, Kingston (CA)

(21) Appl. No.: 19/332,758

(22) Filed: Sep. 18, 2025

Related U.S. Application Data
(60) Provisional application No. 63/695,914, filed on Sep. 18, 2024.

(51) Int. Cl. B22F 10/85; B22F 10/28; B22F 10/36; B22F 12/90; B33Y 50/02

(52) U.S. Cl. CPC B22F 10/85; B22F 10/28; B22F 10/36; B22F 12/90; B33Y 50/02

(57) ABSTRACT

A controller for a laser powder bed fusion (LPBF) printing apparatus receives imaging data obtained during printing of at least one layer of a build by the printing apparatus, processes the imaging data, and generates a surface profile of the at least one layer. The controller calculates values representing in situ height difference (HD) and in situ surface smoothness (SS) of the surface profile of the at least one layer. The HD and SS values are input to an algorithm trained to determine a densification rate of the at least one layer based on a correlation of HD and SS values with one or more printing process parameters. Based on the HD and SS values the algorithm outputs one or more control signals corresponding to the one or more printing process parameters to the LPBF printing apparatus to control printing according to a target densification rate in real time.

### RELATED APPLICATION

This application claims the benefit of the filing date of U.S. Application No. 63/695,914, filed Sep. 18, 2024, the contents of which are incorporated herein by reference in their entirety.

### FIELD

This invention relates generally to the field of additive manufacturing. More specifically, the invention relates to methods and controllers for controlling laser powder bed fusion process parameters in real time during printing to optimize build quality and consistency.

### BACKGROUND

The laser powder bed fusion (LPBF) process, a predominant metal 3D printing technique, is widely adopted in industry, yet its fundamental dynamics are complex and not fully under control despite existing approaches [1, 2]. There are persistent challenges in minimizing and preventing defects while ensuring product consistency. Defects primarily arise due to deviations from optimal processing conditions, either during a single build or from one build to the next. The root cause is inherent to the thermally based additive manufacturing (AM) process where the internal micro- and macro-structural integrity of the build (e.g., porosity content, or densification) is controlled by the heat input rate and thus the resulting thermal history, i.e., temperature distribution within the build. The heat/temperature evolution in LPBF, in turn, is intricately linked to (1) the set process parameters (e.g., laser power and beam velocity), as well as (2) the geometry of the build (e.g., variation of the build cross-section along the build height, or the Z axis). While the former is set to fixed values at the start of the print, the latter is dependent upon the build geometry and height and cannot be taken into account in process design. Moreover, given the current stat of the art, the geometry/height dependency of heat evolution is poorly understood and is not incorporated in any existing process control paradigm across the AM field. As a result, the metal AM industry currently faces the challenge of maintaining part quality consistency (e.g., densification) within single builds, as well as among builds of the same material but different geometries.

### SUMMARY

In one aspect of the invention there is provided a controller for a laser powder bed fusion (LPBF) printing apparatus, comprising; an input that receives imaging data from an imaging device, the imaging data being produced during printing of at least one layer of a build by the LPBF printing apparatus; a processor that processes the imaging data and generates a surface profile of at least a portion of the at least one layer of the build; and (i) calculates a value representing in situ height difference (HD) based on a height variance between contour and infill areas of the surface profile of the at least one layer; (ii) calculates a value representing in situ surface smoothness (SS) of the surface profile of the at least one layer; (iii) inputs the in situ HD and in situ SS values to an algorithm trained to determine a densification rate of the current layer based on a correlation of HD and SS values with one or more LPBF printing process parameters; (iv) outputs one or more control signals corresponding to the one or more LPBF printing process parameters to the LPBF printing apparatus to control printing of at least one additional layer of the build according to a selected densification rate in real time.

In another aspect of the invention there is provided a method for controlling a laser powder bed fusion (LPBF) printing apparatus, comprising; using an imaging device to provide imaging data of at least one layer of a build during printing by the LPBF printing apparatus; using a processor to process the imaging data and generate a surface profile of at least a portion of the at least one layer, including: (i) calculating a value representing in situ height difference (HD) based on a height variance between contour and infill areas of the surface profile of the at least one layer; (ii) calculating a value representing in situ surface smoothness (SS) of the surface profile of the at least one layer; (iii) inputting the in situ HD and in situ SS values to an algorithm trained to determine a densification rate of the current layer based on a correlation of HD and SS values with one or more LPBF printing process parameters; (iv) outputting one or more control signals corresponding to the one or more LPBF printing process parameters to the LPBF printing apparatus to control printing of at least one additional layer of the build according to a selected densification rate in real time.

In another aspect of the invention there is provided a non-transitory computer readable media for use with a processor, the computer readable media having stored thereon instructions that when executed by the processor, cause the processor to execute processing steps for controlling a laser powder bed fusion (LPBF) printing apparatus, comprising; receiving imaging data of at least one layer of a build during printing by the LPBF printing apparatus; processing the imaging data and generating a surface profile of at least a portion of the at least one layer, including: (i) calculating a value representing in situ height difference (HD) based on a height variance between contour and infill areas of the surface profile of the at least one layer; (ii) calculating a value representing in situ surface smoothness (SS) of the surface profile of the at least one layer; (iii) inputting the in situ HD and in situ SS values to an algorithm trained to determine a densification rate of the current layer based on a correlation of HD and SS values with one or more 3D printing process parameters; (iv) outputting one or more control signals corresponding to the one or more LPBF printing process parameters to the LPBF printing apparatus to control printing of at least one additional layer of the build according to a selected densification rate in real time.

According to one embodiment, the controller comprises: an input that receives imaging data from an imaging device, the imaging data being produced during printing of at least a current layer of a build by the LPBF printing apparatus; a processor that processes the imaging data and generates a surface profile of the at least the current layer of the build; and (i) calculates a value representing in situ height difference (HD) based on a height variance between contour and infill areas of the surface profile of the current layer; (ii) calculates a value representing in situ surface smoothness (SS) of the surface profile of the current layer; (iii) inputs the in situ HD and in situ SS values to a machine learning algorithm trained to determine a densification rate of the current layer based on a correlation of HD and SS values with one or more LPBF printing process parameters; (iv) determines whether to update the one or more LPBF printing process parameters of the current layer to achieve a target densification rate; and (v) outputs the one or more control signals to the LPBF printing apparatus to control the one or more LPBF printing process parameters during printing of at least one additional layer of the build according to the target densification rate in real time.

According to one embodiment, the method may include carrying out steps (i) to (v) above.

According to one embodiment, the computer readable media may have stored thereon instructions that when executed by the processor, cause the processor to execute processing steps for (i) to (v) above.

In accordance with the above aspects, in some embodiments the imaging data may be produced by an imaging device based on low coherence scanning interferometry, optical tomography (OT), confocal laser scanning microscopy/tomography, or X-ray microtomography.

In accordance with the above aspects, in some embodiments calculating the HD may comprise determining a variance in mean height (Z value) between outer and inner areas of the at least one layer of the build.

In accordance with the above aspects, in some embodiments calculating the SS may comprise subjecting the Z value to a transform function to calculate a power spectrum of the at least one layer of the build, and determining an area under the power spectrum curve.

In accordance with the above aspects, in some embodiments the transform function is selected from a fast Fourier transform (FFT) and a discrete Fourier transform (DFT).

In accordance with the above aspects, in some embodiments the one or more control signals output by the controller control at least one LPBF printing parameter selected from laser beam power and laser beam velocity.

### BRIEF DESCRIPTION OF THE DRAWINGS

For a greater understanding of the invention, and to show more clearly how it may be carried into effect, embodiments will be described, by way of example, with reference to the accompanying drawings, wherein:

FIG. 1 is a diagram showing a method for determining a surface profile including an average Z-value from imaging data of a build layer of a LPBF process, according to one embodiment.

FIG. 2 is a diagram showing a method for determining a surface profile including a power spectrum density from imaging data of a build layer of a LPBF process, according to one embodiment.

FIG. 3 is a plot showing a relationship between a scalar value representing height difference (HD) and build layer porosity and laser volumetric energy density (VED) for a build layer of a LPBF process, according to one embodiment.

FIG. 4 is a plot showing a relationship between a scalar value representing surface smoothness (SS) and build layer porosity and VED for a build layer of a LPBF process, according to one embodiment.

FIG. 5 is a diagram showing a closed-loop control system for an LPBF process, according to one embodiment.

FIG. 6 is a flow chart of a control algorithm for a LPBF process, according to one embodiment.

FIG. 7 shows plots of surface smoothness (diamonds) and height difference (triangles) for a coupon printed with constant process parameters (upper panel, “Constant”) and for a coupon printed with controlled laser power (lower panel, “Controlled”), as a function of VED across the 100 layers; insets are height maps obtained for the constant and controlled coupons at layers 5, 40, and 100.

FIG. 8 shows the height maps obtained for the constant and controlled coupons at layers 5, 40, and 100, together with cross sections of the complete builds.

### DETAILED DESCRIPTION OF EMBODIMENTS

One aspect of the invention relates to methods for controlling a LPBF 3D printer during a printing operation based on in-situ surface profiling of one or more printed layers of the build. In some embodiments, topological characteristics of one or more printed layers may be condensed into representative variables such as, for example, height difference and surface smoothness. As described herein, such variables are experimentally verified to correlate well with the build's densification rate, which is closely linked to selected individual process parameters (e.g., laser beam power) or combined process parameters (e.g., volumetric energy density, VED). Other representative variables, such as the evolution of length scales emerging from the surface profiles, may also be used either independently or together with one or more of height difference and surface smoothness to correlate process parameters with build quality (e.g., densification rate). Embodiments may include a monitoring and control algorithm that can be trained for a given material/powder of a printing operation, and can effectively use the in situ topological characteristics of printed layers as the basis for real-time correction of one or more process parameters (e.g., laser beam power, beam velocity) in order to obtain or maintain a set value for densification rate. Thus, embodiments provide tracking and control mechanisms, operating in situ, that allow for real-time optimization of build characteristics by dynamically controlling one or more process parameters. Embodiments may also provide real-time determination and analysis of inter-layer statistics, and real-time checks on build characteristics such as surface roughness as well as printer characteristics such as recoater blade condition/damage and powder packing density, and the ability to dynamically respond to deviations in such statistics and characteristics to maintain optimal densification rate of the build layers. Embodiments may integrate machine learning (ML) in a process control algorithm, e.g., ML-enabled feedback loop.

According to embodiments, surface profiling of one or more printed layers of the build may be achieved using a high resolution imaging system such as, for example, an imaging system based on low coherence scanning interferometry (e.g., an optical coherence tomography (OCT) camera) [3] or other mapping/imaging technologies such as optical tomography (OT) [4, 5], confocal laser scanning microscopy/tomography (LSM) [6] and X-ray microtomography (microCT) [7], any of which may generate images or scans of the printed surface to directly generate point-by-point (e.g., pixelated) surface height data that can be used to produce a surface profile and generate a height map. The surface profile (e.g., height map derived from point-by-point pixel data) for a printed layer is evaluated for the layer's average height evolution. In one embodiment, this may be achieved by computing the variance in mean height, i.e., Z value, between the contour and infill areas of a layer of the build for an optical image obtained using an inline coherent imaging camera, referred to as “height difference” (HD) henceforth. According to embodiments, a surface profile may be generated for an entire printed layer or for at least a portion of a printed layer.

In some embodiments the quality and consistency of the printed surface may then be examined using a transform function such as a fast Fourier transform (FFT) analysis, discrete Fourier transform (DFT) analysis, etc. In one embodiment, the power spectrum density (PSD) is computed based on the output data of the imaging system. For example, a 1D FFT profile may be derived by averaging the 2D power spectrum in a single direction. The area under this curve may then be determined (using, e.g., the trapz function in Matlab™ (The MathWorks, Inc.)) resulting in a scalar value representing the “surface smoothness” (SS).

Analyses according to such embodiments provide two representative scalar values, HD and SS, which may be experimentally validated for a given LPBF printing process, powder material, etc. Studies conducted to date confirm that the scalar values HD and SS demonstrate a strong correlation with the internal densification of the build. Based on the relationship between print parameters (e.g., laser beam velocity and power) and densification, methods as described herein can integrate machine learning (ML) enabled feedback loops into control systems for real-time process control during printing. The ML based algorithms may be trained for specific input materials to obtain the optimum thresholds for HD and SS.

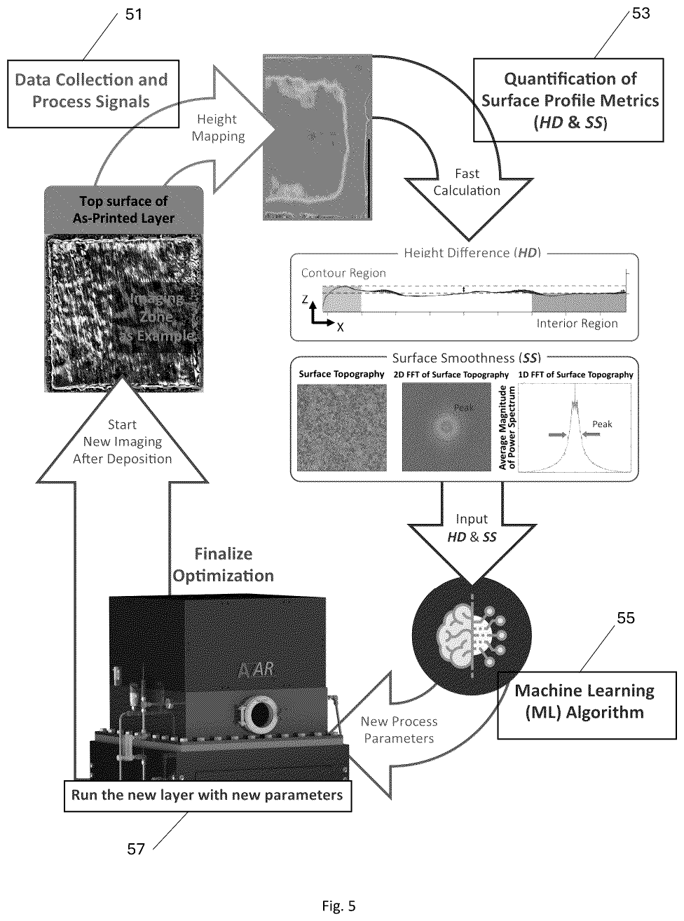

FIG. 5 illustrates a process optimization framework for an LPBF process, according to one embodiment. It incorporates machine learning to analyze and adjust process parameters based on in-situ surface profiling. A closed-loop control system continuously monitors the printing process, analyzes surface quality metrics, and optimizes the process parameters in real-time (e.g., on a layer-by-layer basis, or every second layer, or selected layers or numbers of layers, etc.) for build quality and efficiency. The following is a summary of key steps of the process:

At 51, Data Collection and Process Signals, data are collected from an imaging system during the ongoing printing process as height maps (surface profiles). The imaging system may implement an imaging technique (e.g., low-coherence scanning interferometry) to scan the top surface of a printed layer. A height map representing the surface topography of the printed layer is then created.

At 53, Quantification of Surface Profile Metrics (HD & SS), HD and SS values are calculated as input for a machine learning algorithm.

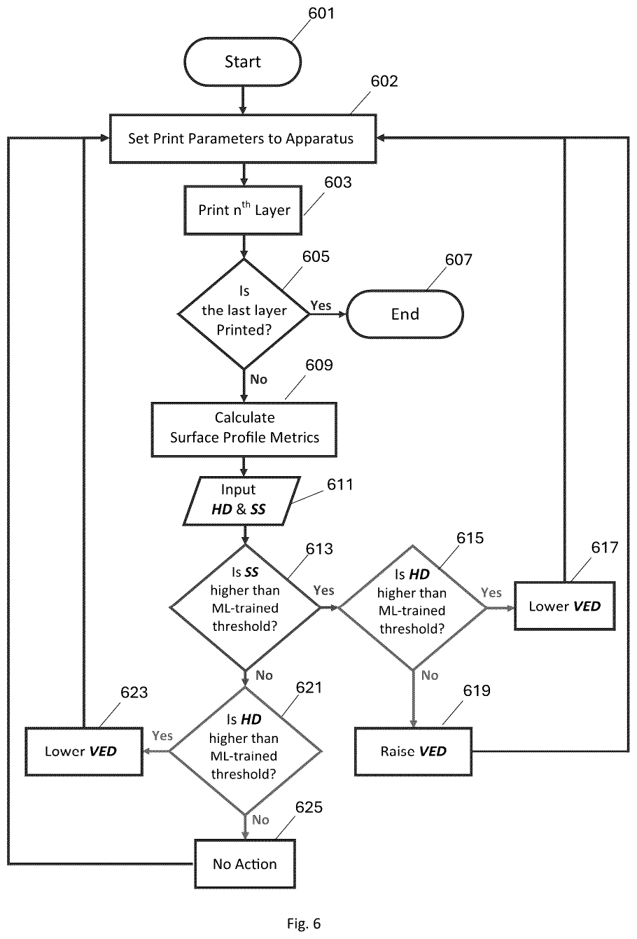

At 55, Machine Learning (ML) Algorithm, input data (HD & SS) are used to train a model that predicts optimal process parameters. The ML algorithm analyzes the relationship between HD, SS, and process parameters to identify the best settings for achieving desired surface quality and thus the target build characteristics. (More details are provided in the embodiment shown in FIG. 6.)

At 57, Run the New Layer with New Parameters, the controller implements the new process parameters determined by the ML algorithm to print the next layer. Upon deposition of the new layer the imaging system acquires new imaging data which are then input to data collection and process signals at 51 to repeat the process. The system may run continuously for all printed layers or for selected layers or selected numbers of layers. For example, in certain applications such as early stage prototyping it may not be necessary to image and optimize process parameters for every layer.

FIG. 6 is a flow chart showing processing steps of an ML-based control algorithm for an LPBF process, according to one embodiment, wherein the algorithm is designed to optimize the volumetric energy density (VED) based on surface profile metrics. Referring to FIG. 6:

601. Start: The process begins.

602. The LPBF apparatus sets process parameters according to received control signals.

603. Print nth Layer: The current layer is printed.

605. Is the last layer Printed? If the current layer is the last layer, the process ends 607.

609. Calculate Surface Profile Metrics: If the current layer is not the last layer then surface profile metrics HD and SS are calculated from imaging data received from a surface imaging system.

611. Input HD & SS: The calculated HD and SS values are used as inputs for the algorithm.

613. Is SS higher or lower than an optimum threshold? The SS value for the current layer is compared to a SS threshold determined by ML based training the algorithm according to the specific input material(s) being used, the desired (i.e., target) densification rate, etc.

615. If the SS value is higher than the SS threshold then the algorithm determines whether the value HD is higher than its respective optimum threshold, also determined by ML based training the algorithm according to the specific input material(s) being used, the desired (i.e., target) densification rate, etc.

617. If both the SS and HD values are higher than their respective optimum thresholds (indicating, e.g., a rough surface due to excessive heat input), then VED is lowered (e.g., by lowering the power, and/or raising the scan velocity), and a corresponding control signal is sent to the LPBF apparatus to control printing of the next layer.

619. If only the SS value is higher than the optimum threshold (indicating, e.g., a rough surface due to insufficient heat input), then VED is raised (e.g., by raising the power, or lowering the scan velocity), and a corresponding control signal is sent to the LPBF apparatus to control printing of the next layer.

621. If at 613 it is determined that the value of SS is lower than or the same as the optimum threshold, then the algorithm determines whether HD is also lower than or the same as its respective optimum threshold.
a. If both the SS and HD values are lower than or the same as their respective threshold, meaning the surface profile is close to or at the optimum and thus the process parameters are to be maintained, then no action is taken 625 and printing of the next layer proceeds with the same process parameters.
b. If the SS value is lower or the same as its respective threshold and the HD value is higher than its respective threshold (indicating, e.g., an excessive edge build-up, thus an excess heat input and thermal stresses), then VED is lowered 623 and a corresponding control signal is sent to the LPBF apparatus to control printing of the next layer.

Thus, according to the embodiment shown in FIG. 6, the algorithm adjusts the VED based on the surface quality metrics, ensuring surface smoothness and edge build-up are kept within the optimum thresholds, thus improving the overall quality and consistency of the printed parts, i.e., maximizing densification and minimizing the thermal stresses, respectively.

Another aspect of the invention relates to a controller configured to implement a strategy according to methods described herein for controlling a LPBF apparatus during a printing operation, e.g., as shown in FIG. 5. A controller may include an electronic processor and a memory. The processor may be implemented at least in part using a suitable digital technology such as, but not limited to, digital signal processor (DSP), field programmable gate array (FPGA), application specific integrated circuit (ASIC), microcontroller unit (MCU), central processing unit (CPU), etc. The processor may include processing capabilities as well as an input/output (I/O) interface through which the processor may receive one or more input signals wherein at least one input signal comprises imaging data produced by an imaging device or system. The imaging data includes in situ surface height data for a LPBF printed layer. The processor may generate output signals through the I/O interface as inputs to a LPBF system, for example, control signals that control LPBF laser beam velocity and/or power during printing. The memory may store data and instructions or code (i.e., an algorithm, software, etc.) executable by the processor. The memory may include various forms of non-volatile (i.e., non-transitory) memory including flash memory or read only memory (ROM) including various forms of programmable read only memory (e.g., PROM, EPROM, EEPROM) and/or volatile memory including random access memory (RAM) including static random access memory (SRAM), dynamic random access memory (DRAM) and synchronous dynamic random access memory (SDRAM).

The memory may store executable computer code which is configured to control at least certain aspects of operation of a LPBF system in accordance with methods described herein. For example, the computer code, when executed by the processor, may be configured to analyze input imaging data and generate control signals that control laser beam velocity and power of the LPBF system to achieve a desired rate and uniformity of densification of a printed layer. In one embodiment the controller executes computer code that implements a control algorithm according to the embodiment shown in FIG. 6. The memory may also store data (e.g., as a look-up table, etc.) corresponding to a relationship between one or more print parameters (e.g., laser beam velocity, laser beam power) and densification for specific AM materials used by the LPBF system.

The processor may support an output device, a graphical user interface (GUI), etc., and the output device may comprise a touch screen to allow user input and control. Alternatively, and/or additionally, an input device such as a keyboard, mouse, etc. may facilitate user input and control. User input and control may comprise the user entering commands and selecting menu options to set LPBF system parameters, etc. The controller may be configured to implement a software application (i.e., an APP) running locally or remotely on a processing device such as a smart phone, tablet, laptop computer or other computer.

Another aspect of the invention relates to non-transitory computer readable media for use with a processor, the computer readable media having stored thereon instructions that when executed by the processor, cause the processor to execute processing steps for controlling a laser powder bed fusion (LPBF) 3D printing apparatus. The instructions may cause the processor to receive imaging data of at least one layer of a build during printing by the 3D printing apparatus, process the imaging data and generate a surface profile of the at least one layer. The processor may calculate one or more representative variables for the at least one layer, such as, for example, height difference, surface smoothness, evolution of length scales emerging from the surface profile, etc. The processor may input the one or more representative variables to an algorithm trained with experimentally verified data to correlate the one or more variables with the build's densification rate, which is closely linked to selected process parameters, and output one or more control signals to the LPBF printing apparatus to achieve the desired densification rate of printed layers in real time. In one embodiment, the stored instructions cause the processor to carry out at least a portion of the control algorithm shown in FIG. 6.

Methods, controllers, and computer readable media according to embodiments described herein, and variants thereof, may be implemented and/or adapted for use with substantially any LPBF 3D printer or powder based printing device, as would be readily apparent to one of ordinary skill in the art.

The invention is further described by way of the following non-limiting examples.

### Example 1

This example describes analysis of the surface and cross section of 3D printed coupons (10×10×4 mm made of AlSi10Mg and HX-12) using a LPBF 3D printer that was custom built in-house, wherein surface imaging and profiling are used to determine HD and SS values with respect to relative thresholds, which values may be used to adjust printing parameters to obtain optimum settings for each material based on the surface analysis.

Images of all printed coupons were captured from both a top-down perspective and an angled view to examine the surface profiles and obtain closer shots of the hatches. For this example, an inline coherent imaging system was used off-situ (LDD-700, IPG Photonics Corp.) to capture images of the printed coupons, i.e., to acquire 2D height maps of the topmost printed layer. To acquire higher-resolution images, each coupon was divided into four tiles and each corner was captured one corner at a time. Images were captured for two coupons with different energy density levels, one with lower VED and the other with higher volumetric energy density.

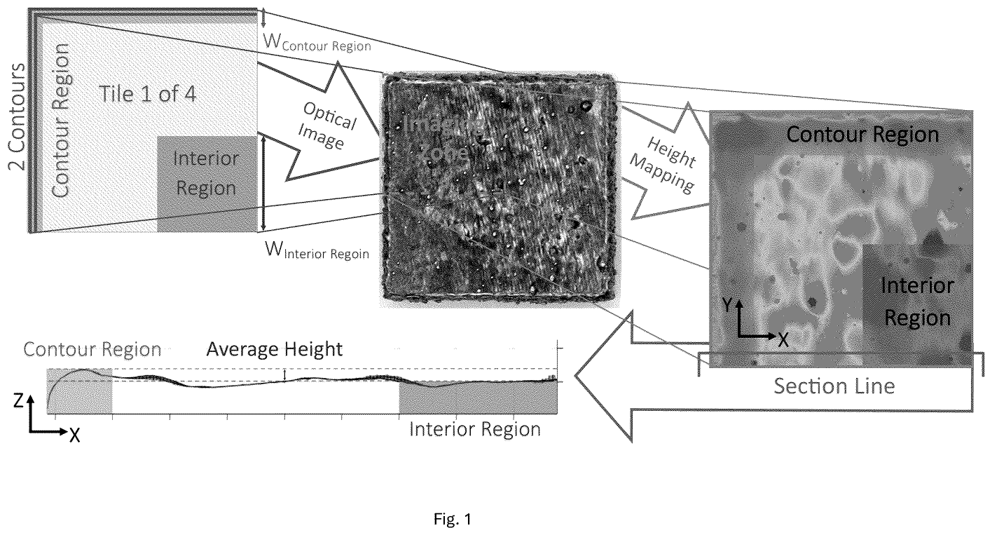

To determine the average height, the variance in mean height (Z Value) between the outer and inner areas were calculated (see e.g., FIG. 1). The overall average height of a coupon was derived from the mean of the calculated values obtained from all four tiles.

Each coupon was halved and quartered, and a panoramic image was obtained using an optical microscope. Image J software was used to stitch the images together and conduct porosity analysis.

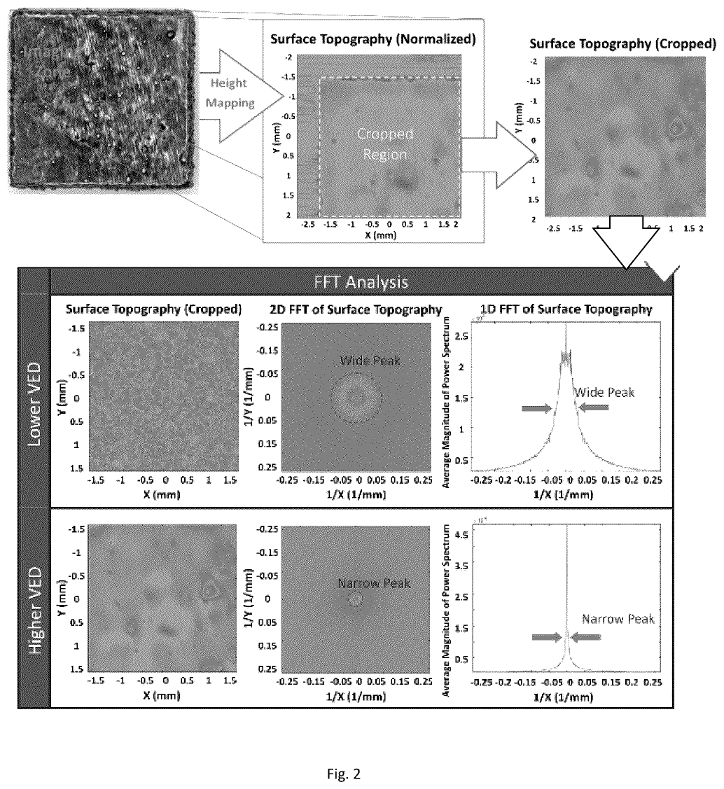

FFT analysis was then conducted (FIG. 2). Initially, the power spectrum of the imaging data was determined using FFT. Subsequently, the average value of the 2D power spectrum in a single direction was determined to generate a 1D FFT profile. The area under the curve was then calculated using the trapz function in Matlab™. The overall average power spectrum of a coupon was derived from the mean of the calculated values obtained from all four tiles. The same method was applied to calculate the full-width half-maximum (FWHM) of each tile. The FFT outputs and analysis figures for two coupons, one printed with lower VED and the other with higher VED, are shown in the lower portion of FIG. 2.

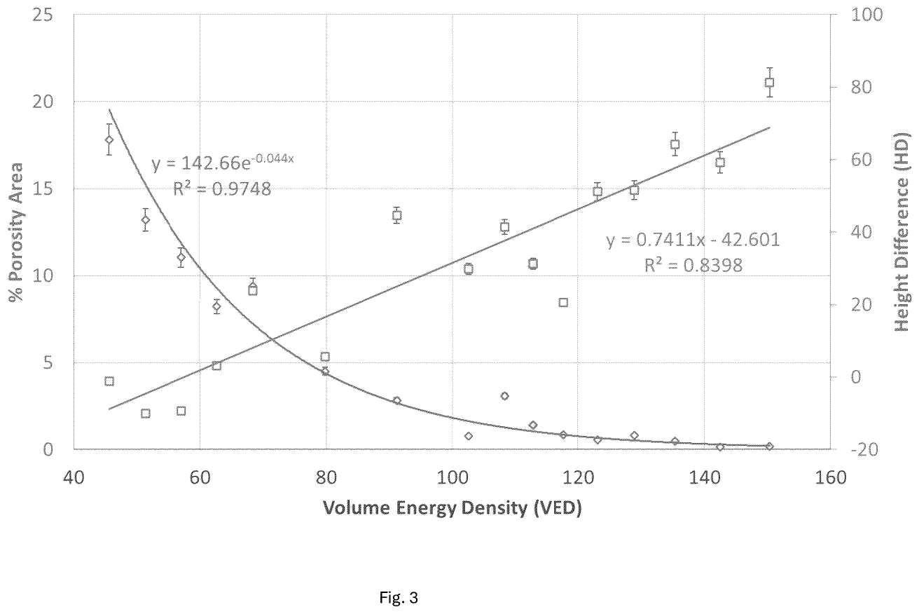

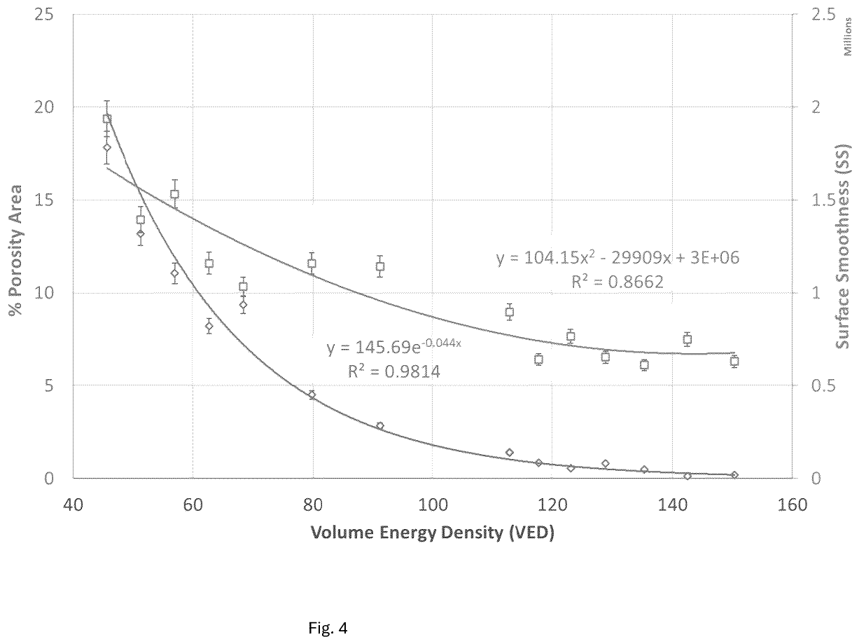

Two representative scalar values, HD and SS, were determined for the LPBF printed AlSi10Mg coupons. FIG. 3 shows the relationship between HD, percent porosity, and VED and FIG. 4 shows the relationship between SS, percent porosity, and VED. The plots confirm that the scalar values HD and SS demonstrate a strong correlation with the internal densification of the build. ML-enabled feedback loops were trained based on these relationships (see, e.g., FIG. 6) and they may be implemented in a LPBF controller to control process parameters of the LPBF apparatus, including laser beam velocity and power, to achieve optimal densification of the build layers in real-time.

### Example 2

This example describes real-time monitoring and control of LPBF 3D printing using the same imaging system and printer as in Example 1.

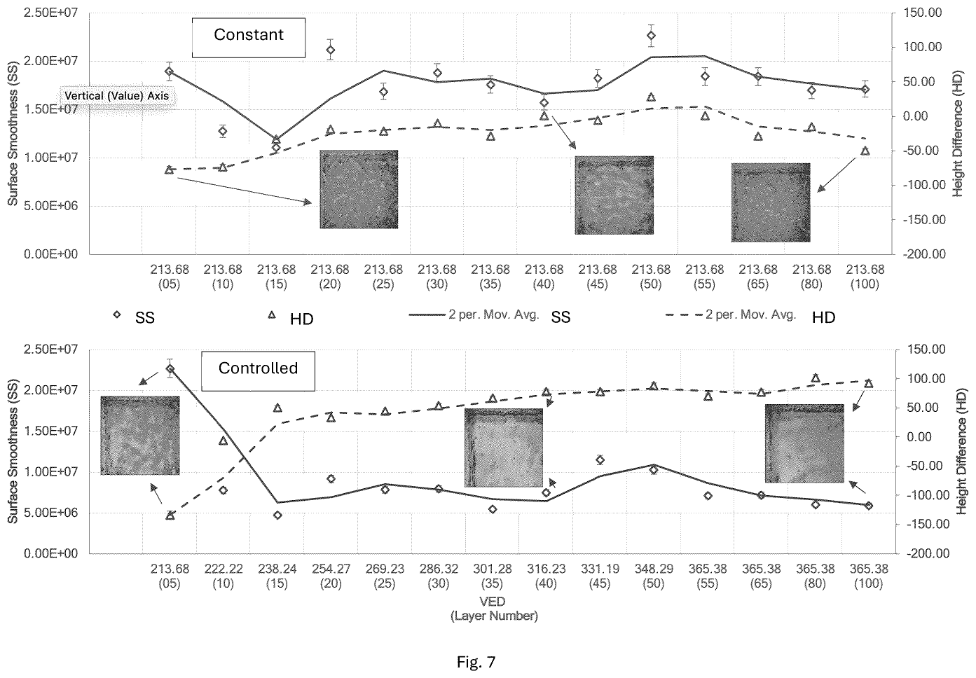

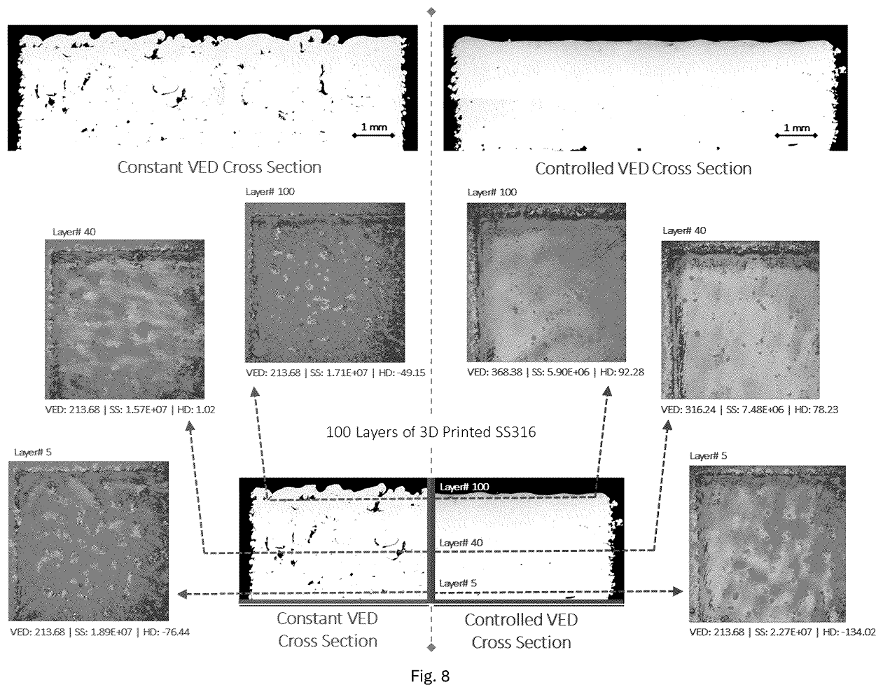

Two coupons (10×10×3 mm) were printed with SS316 powder for 100 layers of 30 μm each. The starting parameters for both coupons were from a known non-optimized set that generates a high level of porosity content (Table 1). For one coupon (“constant”) the starting parameters were held constant throughout the build, and for the other coupon (“controlled”) the VED was controlled by changing the laser power according to a control algorithm based on the embodiment shown in FIG. 6. For both coupons, the process parameters of beam velocity and hatch spacing were held constant throughout the build, at 400 mm/s and 75 μm, respectively. The imaging system was used for real-time capture of 2D height maps from a top-down perspective of printed layers of the coupons. Throughout the build, in situ imaging was carried out on a fixed corner of each coupon, and the data were input to the control algorithm which extracted SS and HD values from the 2D height maps. The control algorithm determined laser power according to the SS and HD values extracted from the 2D height maps, and a control signal corresponding to the corrected laser power was applied to only the controlled coupon build (Table 1). The imaging was performed after every five layers until reaching the optimized laser power (at layer 55, according to Table 1, each time by raising the laser power by 5% of the current value. The laser power was raised following the decreasing and increasing trends of SS and HD, respectively, until reaching a VED at which both SS and HD values remained consistently stable (at layer 55, see FIG. 7), i.e., exhibiting less than about 10% variation. In FIG. 7 the height maps obtained for the constant and controlled coupons at layers 5, 40, and 100 are presented, which clearly show less height variation in the controlled coupon. FIG. 8 also shows the height maps obtained for the constant and controlled coupons at layers 5, 40, and 100, together with cross sections of the complete builds, wherein it can be seen that the VED correction effectively mitigated the porosity formation beyond layer 5 for the controlled VED coupon versus the constant VED coupon.

TABLE 1
Process parameters and measured HD and SS for layers of
a constant coupon build and a controlled coupon build.

| | | | | | Height Difference | | Surface | |
|---|---|---|---|---|---|---|---|---|
| | VED (J/mm³) | | Power (W) | | (HD) (μm) | | Smoothness (SS) | |
| Layer | Constant | Controlled | Constant | Controlled | Constant | Controlled | Constant | Controlled |
| 5 | 213.68 | 213.68 | 200 | 200 | −76.44 | −134.02 | 1.89E+07 | 2.27E+07 |
| 10 | 213.68 | 222.22 | 200 | 208 | −73.39 | −5.77 | 1.27E+07 | 7.77E+06 |
| 15 | 213.68 | 238.25 | 200 | 223 | −32.29 | 51.26 | 1.10E+07 | 4.73E+06 |
| 20 | 213.68 | 254.27 | 200 | 238 | −18.41 | 32.85 | 2.12E+07 | 9.16E+06 |
| 25 | 213.68 | 269.23 | 200 | 252 | −21.19 | 43.83 | 1.69E+07 | 7.82E+06 |
| 30 | 213.68 | 286.32 | 200 | 268 | −9.95 | 54.5 | 1.88E+07 | 7.91E+06 |
| 35 | 213.68 | 301.28 | 200 | 282 | −29.02 | 67.3 | 1.76E+07 | 5.45E+06 |
| 40 | 213.68 | 316.24 | 200 | 296 | 1.02 | 78.23 | 1.57E+07 | 7.48E+06 |
| 45 | 213.68 | 331.2 | 200 | 310 | −5.78 | 77.62 | 1.82E+07 | 1.15E+07 |
| 50 | 213.68 | 348.29 | 200 | 326 | 28.32 | 88.17 | 2.26E+07 | 1.02E+07 |
| 55 | 213.68 | 365.38 | 200 | 342 | 0.24 | 70.42 | 1.84E+07 | 7.09E+06 |
| 65 | 213.68 | 365.38 | 200 | 342 | −28.98 | 77.27 | 1.84E+07 | 7.18E+06 |
| 80 | 213.68 | 365.38 | 200 | 342 | −14.93 | 101.88 | 1.70E+07 | 6.00E+06 |
| 100 | 213.68 | 365.38 | 200 | 342 | −49.15 | 92.28 | 1.71E+07 | 5.90E+06 |

All cited documents are incorporated herein by reference in their entirety.

### EQUIVALENTS

Those of ordinary skill in the art will recognize, or be able to ascertain through routine experimentation, equivalents to the embodiments described herein. Such equivalents are within the scope of the invention and are covered by the appended claims.

### REFERENCES

[1] Spears, T. G. and S. A. Gold, In-process sensing in selective laser melting (SLM) additive manufacturing. 2016, Integr Mater Manuf Innov. 5, no. 1, pp. 16-40, doi: 10.1186/S40192-016-0045-4/TABLES/3.
[2] Mani, M., et al., Measurement Science Needs for Real-time Control of Additive Manufacturing Powder Bed Fusion Processes,” February 2015, doi: 10.6028/NIST.IR.8036.
[3] DePond, P. J., et al., In situ measurements of layer roughness during laser powder bed fusion additive manufacturing using low coherence scanning interferometry. 2018, Materials & Design 154, pp. 347-359.
[4] Mohr, G., et al., In-situ defect detection in laser powder bed fusion by using thermography and optical tomography-comparison to computed tomography. 2020, Metals (Basel), vol. 10, no. 1, doi: 10.3390/met10010103.
[5] Zenzinger, G., et al., Process monitoring of additive manufacturing by using optical tomography, 2015, AIP Conf Proc, vol. 1650, no. 1, p. 164, doi: 10.1063/1.4914606.
[6] Oleksiievets, N., et al., Single-molecule fluorescence lifetime imaging using wide-field and confocal-laser scanning microscopy: A comparative analysis. 2022, Nano Letters 22, no. 15, pp. 6454-6461.
[7] Du Plessis, A., et al., Standard method for microCT-based additive manufacturing quality control 1: Porosity analysis. 2018, MethodsX, vol. 5, pp. 1102-1110.

1. A controller for a laser powder bed fusion (LPBF) printing apparatus, comprising;
an input that receives imaging data from an imaging device, the imaging data being produced during printing of at least a current layer of a build by the LPBF printing apparatus;
a processor that processes the imaging data and generates a surface profile of the at least the current layer of the build; and
(i) calculates a value representing in situ height difference (HD) based on a height variance between contour and infill areas of the surface profile of the current layer;
(ii) calculates a value representing in situ surface smoothness (SS) of the surface profile of the current layer;
(iii) inputs the in situ HD and in situ SS values to a machine learning algorithm trained to determine a densification rate of the current layer based on a correlation of HD and SS values with one or more LPBF printing process parameters;
(iv) determines whether to update the one or more LPBF printing process parameters of the current layer to achieve a target densification rate; and
(v) outputs the one or more control signals to the LPBF printing apparatus to control the one or more LPBF printing process parameters during printing of at least one additional layer of the build according to the target densification rate in real time.

2. The controller of claim 1, wherein the imaging data is produced by an imaging device based on low coherence scanning interferometry.

3. The controller of claim 1, wherein the imaging data is produced by an imaging device based on optical tomography (OT), confocal laser scanning microscopy/tomography, or X-ray microtomography.

4. The controller of claim 1, wherein calculating the HD comprises determining a variance in mean height (Z value) between outer and inner areas of the at least one layer of the build.

5. The controller of claim 4, wherein calculating the SS comprises subjecting the Z value to a transform function to calculate a power spectrum of the at least one layer of the build, and determining an area under the power spectrum curve.

6. The controller of claim 5, wherein the transform function is selected from a fast Fourier transform (FFT) and a discrete Fourier transform (DFT).

7. The controller of claim 5, wherein the one or more control signals output by the controller control at least one LPBF printing parameter selected from laser beam power and laser beam velocity.

8. A method for controlling a laser powder bed fusion (LPBF) printing apparatus, comprising;
using an imaging device to provide imaging data of at least a current layer of a build during printing by the LPBF printing apparatus;
using a processor to process the imaging data and generate a surface profile of the at least the current layer, including:
(i) calculating a value representing in situ height difference (HD) based on a height variance between contour and infill areas of the surface profile of the current layer;
(ii) calculating a value representing in situ surface smoothness (SS) of the surface profile of the current layer;
(iii) inputting the in situ HD and in situ SS values to a machine learning algorithm trained to determine a densification rate of the current layer based on a correlation of HD and SS values with one or more LPBF printing process parameters;
(iv) determining whether to update the one or more LPBF printing process parameters of the current layer to achieve a target densification rate; and
(v) outputting the one or more control signals to the LPBF printing apparatus to control the one or more LPBF printing process parameters during printing of at least one additional layer of the build according to the target densification rate in real time.

9. The method of claim 8, wherein the imaging data is produced by an imaging device based on low coherence scanning interferometry.

10. The method of claim 8, wherein the imaging data is produced by an imaging device based on optical tomography (OT), confocal laser scanning microscopy/tomography, or X-ray microtomography.

11. The method of claim 8, wherein calculating the HD comprises determining a variance in mean height (Z value) between outer and inner areas of the at least one layer of the build.

12. The method of claim 11, wherein calculating the SS comprises subjecting the Z value to a transform function to calculate a power spectrum of the at least one layer of the build, and determining an area under the power spectrum curve.

13. The method of claim 12, wherein the transform function is selected from a fast Fourier transform (FFT) and a discrete Fourier transform (DFT).

14. The method of claim 12, wherein the one or more control signals output by the controller control at least one LPBF printing parameter selected from laser beam power and laser beam velocity.

15. Non-transitory computer readable media for use with a processor, the computer readable media having stored thereon instructions that when executed by the processor, cause the processor to execute processing steps for controlling a laser powder bed fusion (LPBF) printing apparatus, comprising;
receiving imaging data of at least a current layer of a build during printing by the LPBF printing apparatus;
processing the imaging data and generating a surface profile of the at least the current layer, including:
(i) calculating a value representing in situ height difference (HD) based on a height variance between contour and infill areas of the surface profile of the current layer;
(ii) calculating a value representing in situ surface smoothness (SS) of the surface profile of the current layer;
(iii) inputting the in situ HD and in situ SS values to a machine learning algorithm trained to determine a densification rate of the current layer based on a correlation of HD and SS values with one or more 3D printing process parameters;
(v) determining whether to update the one or more LPBF printing process parameters of the current layer to achieve a target densification rate; and
(v) outputting the one or more control signals to the LPBF printing apparatus to control the one or more LPBF printing process parameters during printing of at least one additional layer of the build according to the target densification rate in real time.

16. The non-transitory computer readable media of claim 15, wherein the imaging data is produced by an imaging device based on low coherence scanning interferometry.

17. The non-transitory computer readable media of claim 15, wherein the imaging data is produced by an imaging device based on optical tomography (OT), confocal laser scanning microscopy/tomography, or X-ray microtomography.

18. The non-transitory computer readable media of claim 15, wherein calculating the HD comprises determining a variance in mean height (Z value) between outer and inner areas of the at least one layer of the build.

19. The non-transitory computer readable media of claim 18, wherein calculating the SS comprises subjecting the Z value to a transform function to calculate a power spectrum of the at least one layer of the build, and determining an area under the power spectrum curve.

20. The non-transitory computer readable media of claim 19, wherein the transform function is selected from a fast Fourier transform (FFT) and a discrete Fourier transform (DFT).

21. The non-transitory computer readable media of claim 19, wherein the one or more control signals output by the controller control at least one LPBF printing parameter selected from laser beam power and laser beam velocity.
